(19) United States
(12) Patent Application Publication
(10) Pub. No.: US 2005/0213109 A1
(43) Pub. Date: Sep. 29, 2005

(54) Sensing device and method for measuring position and orientation relative to multiple light sources

(75) Inventors: Steve Schell, Arcadia, CA (US); Robert Witman, Pasadena, CA (US); Joe Brown, Valencia, CA (US); Thomas Kerekes, Calabasas, CA (US)

Correspondence Address: Evolution Robotics, Inc., 130 West Union Street, Pasadena, CA, 91103, US

(73) Assignee: Evolution Robotics, Inc., Pasadena, CA (US)

(21) Appl. No.: 11/090,405

(22) Filed: Mar. 25, 2005

Related U.S. Application Data
(60) Provisional application No. 60/557,252, filed on Mar. 29, 2004.
(60) Provisional application No. 60/601,913, filed on Aug. 16, 2004.

(51) Int. Cl. G01B 11/14

(52) U.S. Cl. 356/614

(57) ABSTRACT

A sensing device and method of estimating the position and orientation of an object with respect to a local or a global coordinate system is disclosed. The method and device include one or more optical sensor, a signal processing circuitry and a signal processing algorithm to determine the position and orientation. A sensor is positioned within the housing. At least one of the optical sensors used in the method and system outputs information based at least in part on the detection of the signal of one or more light sources.

### RELATED APPLICATION

This application claims the benefit under 35 U.S.C. § 119(e) of U.S. provisional applications No. 60/557,252, filed Mar. 29, 2004 and No. 60/601,913 filed Aug. 16, 2004, the entirety of which is hereby incorporated by reference.

Appendix A

Appendix A, which forms a part of this disclosure, is a list of commonly owned co-pending U.S. patent applications. Each one of the co-pending applications listed in Appendix A is hereby incorporated herein in its entirety by reference thereto.

### BACKGROUND

This invention is generally related to the estimation of position and orientation of an object with respect to a local or a global coordinate system. In particular, the current invention describes methods and sensing devices to measure position and orientation relative to one or more light sources. The method and device comprise one or more optical sensors, signal processing circuitry, signal processing algorithm to determine the positions and orientations. At least one of the optical sensors outputs information based at least in part on the detection of the signal of one or more light sources in this invention.

Description of Related Art

Position estimation has been a topic of interest for applications ranging from autonomous systems, ubiquitous computing, portable objects, tracking of subjects, position tracking of moving objects, position of nodes in ad hoc wireless networks, position tracking of vehicles, and position tracking of mobile devices such as cell phones, personal digital assistants, and the like.

Localization techniques refer to processes by which an object determines its position and orientation relative to a reference coordinate system. The reference coordinate system can be either local (for example, relative to an object of interest) or global. Position estimation can include estimation of any quantity that is related to at least some of an object's six degrees of freedom in three dimensions (3-D). These six degrees of freedom can be described as the object's (x, y, z) position and its angles of rotation around each axis of a 3-D coordinate system, which angles are denoted α, β, and θ and respectively termed “pitch,” “roll,” and “yaw.” Such position estimation can be useful for various tasks and applications. For example, the bearing of an object relative to a stationary station can be useful for allowing the object to servo to the stationary station autonomously. The estimation of the distance of a pet from the front door can be used to alert the owner about a possible problem. For indoor environments, it is typically desired to track the (x, y) position of an object in a two-dimensional (2-D) floor plane and its orientation, θ, relative to an axis normal to the floor plane. That is, it can be convenient to assume that a z coordinate of the object, as well as the object's roll and pitch angles, are zero. The (x, y) position and the θ orientation of an object are referred to together as the pose of the object.

Numerous devices, processes, sensors, equipment, and mechanisms have been proposed for position estimation. These methods can be divided into two main categories. One category uses beacons in the environment to enable position estimation, and the second category uses natural landmarks in the environment. The sensing methods and devices described herein fall into the first category of beacon-based position estimation or localization, this section focuses on beacon-based localization methods.

Optical beacons, a common type of beacon, are artificial light sources in the environment located at fixed positions that can be detected by appropriate sensing devices. These optical beacons can be passive or active. Examples of passive optical beacons include retroreflective materials. By projecting a light source that is co-located with one or more appropriate mobile optical sensors onto a retroreflective material that is fixed in the environment, one can create a signature or signal that can be detected readily using the sensor or sensors. Using the signature or signal, the one or more sensors can determine their positions relative to the beacons and/or relative to the environment.

Active optical beacons emit lights that can be detected by a sensor. The sensor can measure various characteristics of the emitted light, such as the distance to the emitter (using time-of-flight), the bearing to the emitter, the signal strength, and the like. Using such characteristics, one can determine the position of the sensor using an appropriate technique, such as triangulation or trilateration. These approaches, which use active beacons paired with sensors, are disadvantageously constrained by line-of-sight between the emitters and the sensors. Without line-of-sight, a sensor will not be able to detect the emitter.

### SUMMARY OF INVENTION

Embodiments described herein are related to methods and devices for the determination of the position and orientation of an object of interest relative to a global or a local reference frame. The devices described herein comprise one or more optical sensors, one or more optical sources, and one or more signal processors. The poses of the sensors are typically to be determined, and the devices and methods described herein can be used to measure or estimate the pose of at least one sensor, thus the pose of an object associated with the sensor.

Glossary of Terms

Pose: A pose is a position and orientation in space. In three dimensions, pose can refer to a position (x, y, z) and an orientation (α, β, θ) with respect to the axes of the three-dimensional space. In two dimensions, pose can refer to a position (x, y) in a plane and an orientation θ relative to the normal to the plane.

Optical sensor: An optical sensor is a sensor that uses light to detect a condition and describe the condition quantitatively. In general, an optical sensor refers to a sensor that can measure one or more physical characteristics of a light source. Such physical characteristics can include the number of photons, the position of the light on the sensor, the color of the light, and the like.

Position-sensitive detector: A position-sensitive detector, also known as a position sensing detector or a PSD, is an optical sensor that can measure the centroid of an incident light source, typically in one or two dimensions. For example, a PSD can convert an incident light spot into relatively continuous position data.

Segmented Photo Diodes: A segmented photo diode or a SPD is a optical sensor that includes two or more photodiodes arranged with specific geometric relationships. For example, a SPD can provide continuous position data of one or more light source images on the SPD.

Imager: An imager refers to an optical sensor that can measure light on an active area of the sensor and can measure optical signals along at least one axis or dimension. For example, a photo array can be defined as a one-dimensional imager, and a duo-lateral PSD can be defined as a two-dimensional imager.

Camera: A camera typically refers to a device including one or more imagers, optics, and associated support circuitry. Optionally, a camera can also include one or more optical filters and a housing or casing.

PSD camera: A PSD camera is a camera that uses a PSD.

SPD camera: A SPD camera is a camera that uses a SPD.

Projector: A projector refers to an apparatus that projects light. A projector includes an emitter, a power source, and associated support circuitry. A projector can project one or more light spots on a surface.

Spot: A spot refers to a projection of light on a surface. A spot can correspond to an entire projection, or can correspond to only part of an entire projection.

Optical position sensor: An optical position sensor is a device that includes one or more cameras, a signal processing unit, a power supply, and support circuitry and can estimate its position, distance, angle, or pose relative to one or more spots.

CMOS: A complementary metal oxide semicoductor is a low cost semiconductor produced from a manufacturing method to include metal and oxide in the basic chip material.

CCD: A charge-coupled device is an integrated circuit containing an array of linked, or coupled, capacitors. Under the control of an external circuit, each capacitor can transfer its electric charge to one or other of its neighbors. CCDs are used in digital photography and astronomy (particularly in photometry and optical and UV spectroscopy).

### BRIEF DESCRIPTION OF THE DRAWINGS

Features of the method and apparatus will be described with reference to the drawings summarized below. These drawings (not to scale) and the associated descriptions are provided to illustrate embodiments of the method and apparatus and are not intended to limit the scope of the invention.

FIG. 1 is a block diagram illustrating one implementation of an apparatus for position estimation.

FIG. 2 illustrates an example of a use for the position estimation techniques.

FIG. 3 shows one way optical position sensor 202 interacts with optical sources 204 and 205.

FIG. 4 is a block diagram of one embodiment to transform signals on PSD into a pose of a sensor system.

FIG. 5 is a geometrical model associated with one embodiment with references to a global and a local coordinate system.

### DETAIL DESCRIPTION OF THE DRAWINGS

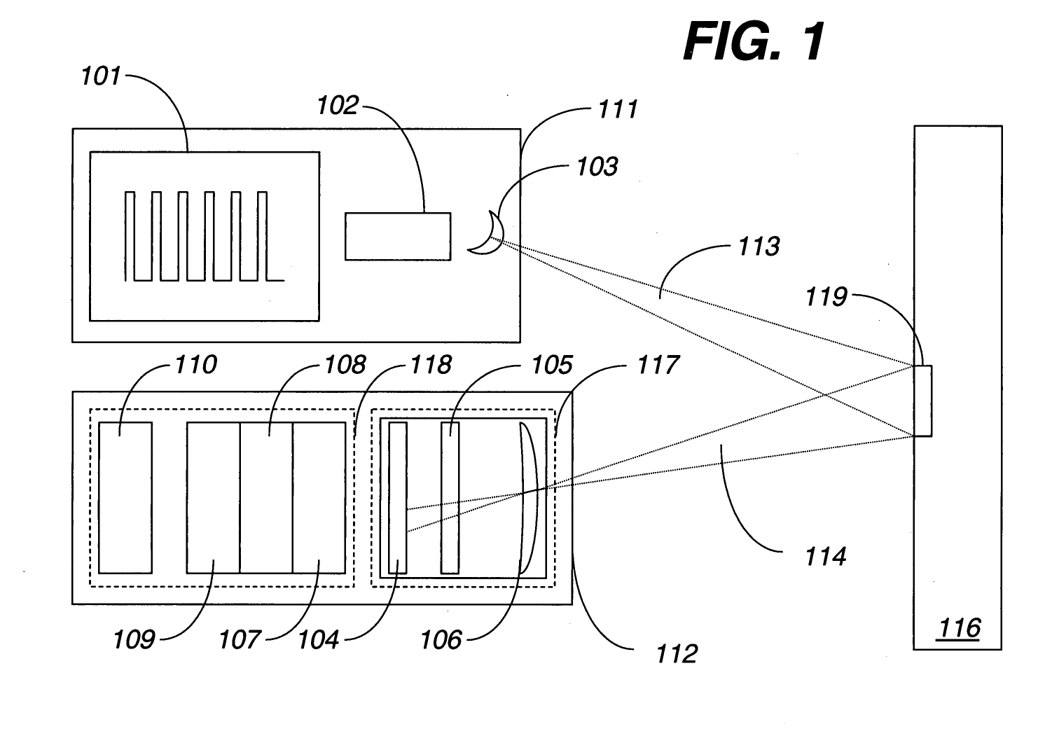

FIG. 1 illustrates a block diagram of components of one embodiment as implemented in an operation. The operating system includes a projector 111 and an optical position sensor 112. The projector 111 emits a light pattern 113 onto a surface 116, which creates a projected light pattern 119. In one embodiment, the light pattern 113 is modulated. The reflection 114 of the projected light pattern 119 is projected onto the optical position sensor 112.

The projector 111 includes a light source 102. By way of example, the light source 102 can be a laser device, an infrared device, and the like, that can be modulated by a modulator 101. Optionally, the light from the light source 102 can pass through one or more lenses 103 to project the light onto the surface 116.

The optical position sensor 112 includes a camera 117 and a processing unit 118. The camera 117 can detect and measure the intensity and position of the light 114 reflected from the surface 116 and can generate corresponding signals that are processed by the signal processing unit 118 to estimate the position of the optical position sensor 112 relative to the projected light pattern 119. It will be understood that the optical position sensor 112 can include multiple cameras 117 and/or multiple processing units 118.

The camera 117 includes an imager 104. The imager 104 can, for example, correspond to a CMOS imager, a CCD imager, an infrared imager, and the like. The camera can optionally include an optical filter 105 and can optionally include a lens 106. The lens 106 can correspond to a normal lens or can correspond to a special lens, such as a wide-angle lens, a fish-eye lens, an omni-directional lens, and the like. Further, the lens 106 can include reflective surfaces, such as planar, parabolic, or conical mirrors, which can be used to provide a relatively large field of view or multiple viewpoints. The lens 106 collects the reflected light 114 and projects it onto the imager 104. The optical filter 105 can constrain the wavelengths of light that pass from the lens 106 to the imager 104, which can advantageously be used to reduce the effect of ambient light, to narrow the range of light to match the wavelength of the light coming from the projector 111, and/or to limit the amount of light projected onto the imager 104, which can limit the effects of over-exposure or saturation. The filter 105 can be placed in front of the lens 106 or behind the lens 106. It will be understood that the camera 117 can include multiple imagers 104, multiple optical filters 105, and/or multiple lenses 106.

The signal processing unit 118 can include analog components and can include digital components for processing the signals generated by the camera 117. The major components of the signal processing unit 118 preferably include an amplifier 107, a filter 108, an analog-to-digital converter 109, and a microprocessor 110, such as a peripheral interface controller, also known as a PIC. It will be understood that the signal processing unit 118 can include multiple filters 108 and/or multiple microprocessors 110.

Embodiments of the apparatus are not constrained to the specific implementations of the projector 111 or the optical position sensor 112 described herein. Other implementations, embodiments, and modifications of the apparatus that do not depart from the true spirit and scope of the apparatus will be readily apparent to one of ordinary skill in the art.

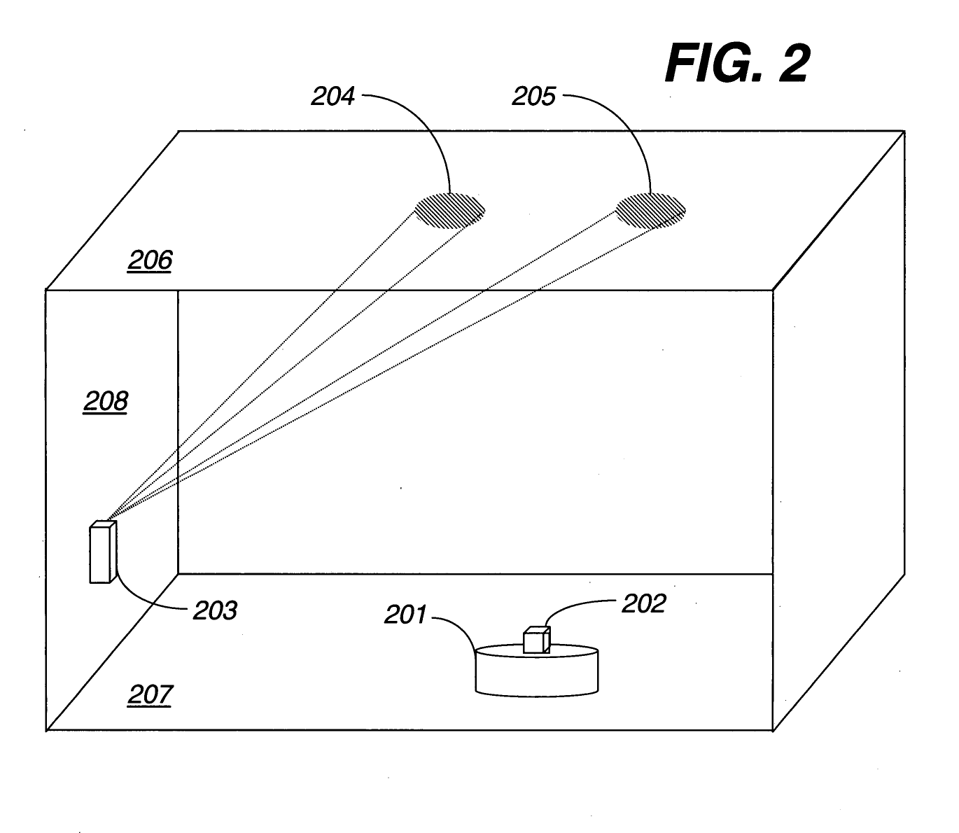

FIG. 2 illustrates an example of a use for the position estimation techniques utilizing the sensor device. An environment includes a ceiling 206, a floor 207, and one or more walls 208. In the illustrated environment, a projector 203 is attached to a wall 208. It will be understood that the projector 203 can have an internal power source, can plug into a wall outlet or both. The projector 203 projects a first spot 204 and a second spot 205 onto the ceiling 206. An optical position sensor 202 is attached to an object 201. The optical position sensor 202 can detect the spots 204, 205 on the ceiling 206 and measure the position (x, y) of the object 201 on the floor plane and the orientation θ of the object 201 with respect to the normal to the floor plane. In one embodiment, the pose of the object 201 is measured relative to a global coordinate system.

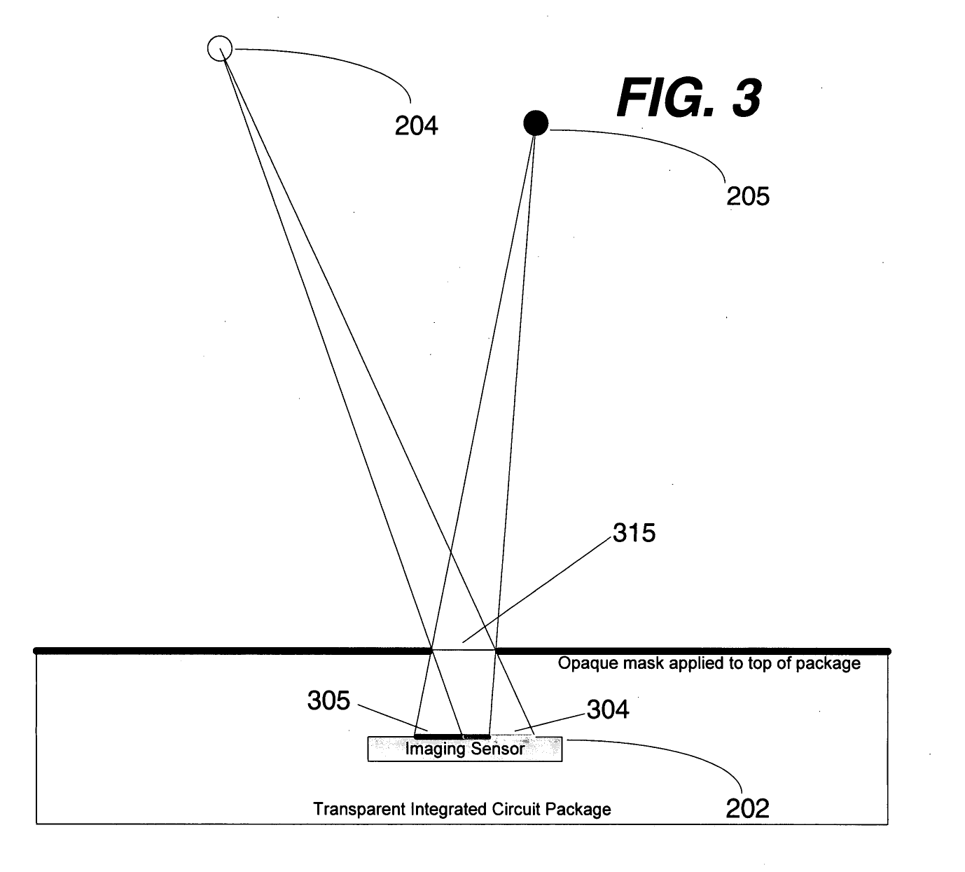

FIG. 3 describes the geometrical relationship between the light sources and the image captured on the sensor device. An optic 315 on top of the sensor device 202 allows the light sources 204, 205 to project light spots 304, 305, respectively, onto the sensor 202. The light images 304, 305 allow the sensor 202 to detect their intensities, or magnitudes. Such detections can take place irrespective of whether the light spots are “focused” or not. As the object on which the sensor 202 is incorporated moves around, the intensity and position of the light spots 304, 305 change accordingly. Based on the coordinate transformation illustrated in the co-pending patent applications, the position and orientation of the mobile unit on which the sensor 202 sits can be estimated.

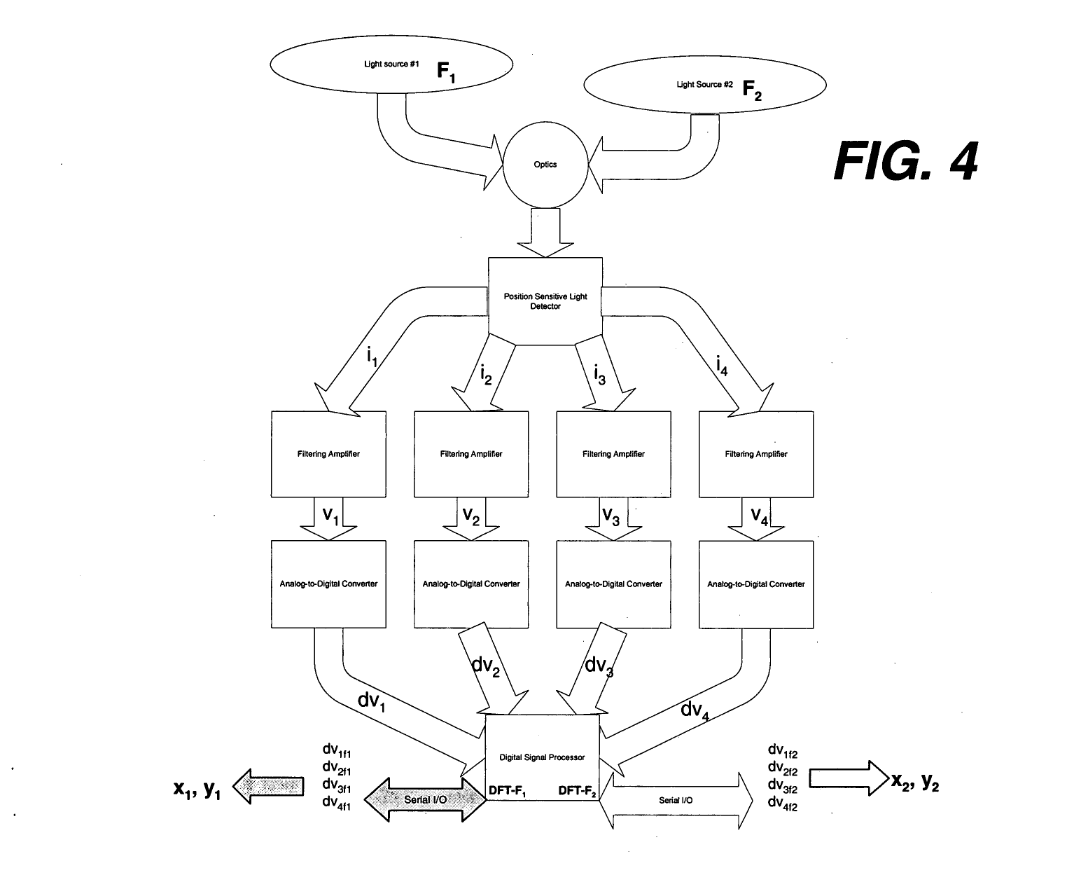

FIG. 4 is a block diagram of the localization sensor system. A localization sensor system 400 has at least one optical sensor 402. The optical sensor 402 includes one or more cameras. The camera can be a two-dimensional PSD camera capable of capturing multiple light spots and/or sources such as light sources 204, 205 in FIG. 4. Each light spot can be modulated with a unique pattern or frequency. The PSD camera is mounted facing the light sources in such a way that its field of view intersects at least a portion of the plane on the enclosure surface where the lights illuminate. The PSD camera provides an indication of the centroid location of the light incident upon its sensitive surface.

The optical sensor 402 can be combined with a lens and one or more optical filters 404 to form a camera in this invention. For example, a PSD sensor can be enclosed in a casing with an open side that fits the lens and optical filters to filter incoming light and reduce effects of ambient light.

Optical sensor 402 described herein can use a wide variety of optical sensors. Some embodiments use digital or analog imaging or video cameras, such as CMOS imagers, CCD imagers, and the like. Other embodiments use PSDs, such as one-dimensional PSDs, angular one-dimensional PSDs, two-dimensional PSDs, duo-lateral PSDs, tetra-lateral PSDs, and the like. Other embodiments use segmented photo diodes, comprising two or more photodiodes arranged with specific geometric relationships.

The optical sensor 402 generates one or more electrical signals. For the purpose of illustration, four signals 412, 414, 416 and 418 are used. However, it should be understood by those skilled in the art that the number of signals generated by the optical sensor 402 varies according to the type of optical sensor 402 utilized.

The electrical signals 412, 414, 416, 418 are further conditioned by one or more signal filters and/or amplifiers 422, 424, 426, 428 to reduce the background noise in the contents of the signal. The other function commonly provided by the filter/amplifier is to increase the signal to noise ratios of the electrical signal suitable for data processing. The filters/amplifiers 422, 424, 426, 428 can be the same in design or different from one another depending on the architecture of the localization systems.

Conditioned signals 432, 434, 436, 438 are generated from the filters/amplifiers ready for digitization. As conceived in this invention, the localization sensor system includes one or more digital converters 440. The digital converter 440 receives conditioned signals 432, 434, 436, 438 and processes them in its circuitry to produce digital information related to individual input. The digital information 450 from digital converter 440 includes at least one channel of information. For illustration purpose, FIG. 4 shows four channels of digital information.

The localization sensor system 400 includes at least one signal processor 460 to process the digital information 450 from converter 440 into multiple channels of coordinate information associated with light source 204, 205 images on PSD sensor 402. The processor employs commonly know techniques including but not limited to time-frequency domain transformation, fast Fourier transform and discrete Fourier transform to separate input information into one or more matrices 480 representing the coordinates of the images captured on PSD sensor 402.

A processor 484 manipulates matrices 480 to identify light source image spots on PSD sensor. The processor 484 includes a means to perform frequency search on the matrices 480, a means to conduct spot calculation to derive the two-dimensional information on the PSD sensor plane, a means to translation multiple two-dimensional coordinates of the images of the light spots on the PSD sensor into a global coordinate system associated with enclosure environment, and a means to determine the orientation, θ, of the object 201 in a global coordinate system associated with the enclosure environment.

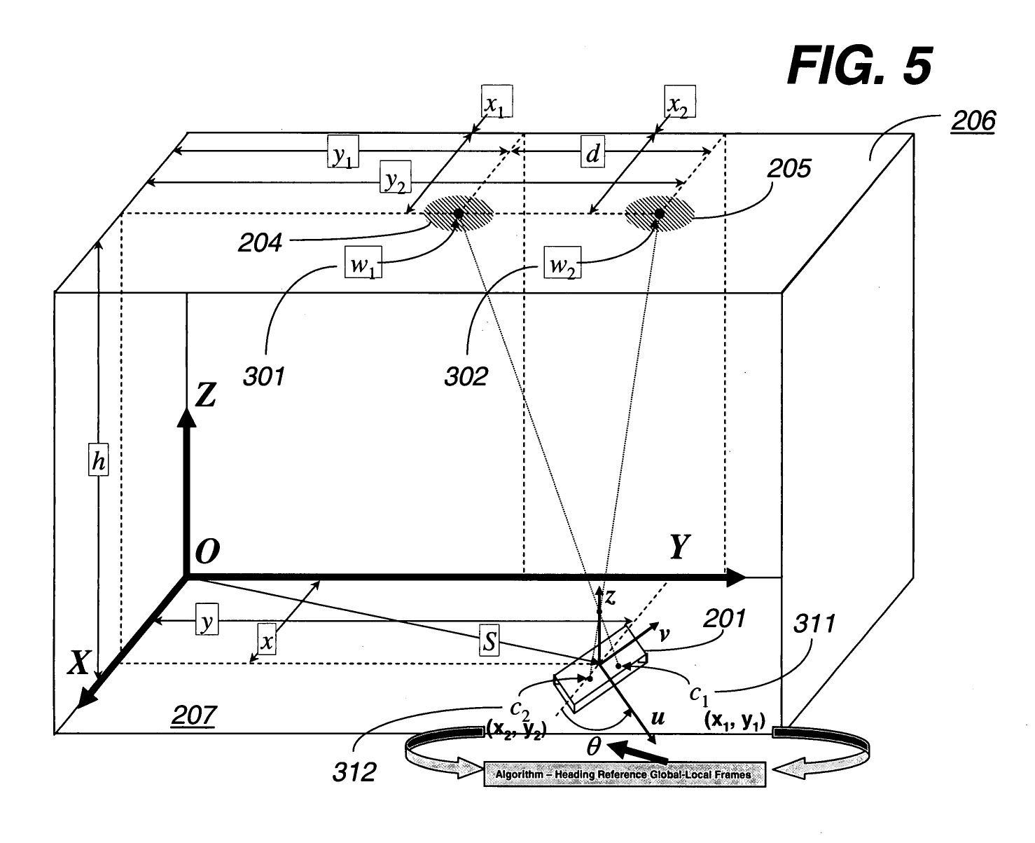

FIG. 5 illustrates a schematic diagram including an enclosure coordinate system 510, and a local coordinate system 520. Light source images C₁ 511 and C₂ 512 on the PSD sensor plane have the coordinate of (x₁, y₁) and (x₂, y₂) respectively on the local coordinate system 520. A processor 530 to calculate the orientation, 0, information of the object 201 is also schematically represented.

### DETAILED DESCRIPTION OF PREFERRED EMBODIMENTS

Although these methods and apparatus will be described in terms of certain preferred embodiments, other embodiments that are apparent to those of ordinary skill in the art, including embodiments that do not provide all of the benefits and features set forth herein, are also within the scope of the invention.

Embodiments advantageously use active optical beacons in position estimation. Advantageously, disclosed techniques minimize or reduce the line-of-sight limitation of conventional active optical beacon-based localization by projecting the light sources onto a surface that is observable from a relatively large portion of the environment. It will be understood that the light sources can include sources of light that are not visible to the naked eye, such as infrared (IR) sources. For example, in an indoor environment, it can be advantageous to project the emitted light from the beacon onto the ceiling. In many indoor environments, the ceiling of a room is observable from most locations within the room.

In one embodiment, the light emitter can advantageously be placed in such a way that it projects onto the ceiling above a destination of interest, and a sensor system can have a photo detector that generally faces the ceiling or is capable of observing the ceiling. The object of interest equipped with the sensor system can advantageously observe the light projection on the ceiling even in the absence of line-of-sight between the object and the destination of interest. In relatively many situations, the object has a line-of-sight view of the ceiling, which enables the object to determine the pose, thus the relative orientation between the object and the destination.

The method and apparatus described herein include numerous variations that differ in the type and numbers of active beacons used, differ in the type and numbers of optical sensors used for detection of reflected light, and differ in the type of signal processing used to determine the pose of an object. Embodiments of the method and apparatus include systems for estimation of the distance of an object relative to another object, estimation of the bearing of an object relative to another object, estimation of the (x, y) position of an object in a two-dimensional plane, estimation of the (x, y, z) position of an object in three-dimensional space, and estimation of the position and orientation of an object in two dimensions or in three dimensions.

The initial position and orientations of the sensors can be unknown, and the apparatus and methods can be used to measure or estimate the position and orientation of one or more of the sensors and the position of the emitted light spots projected on a surface.

A camera position of each observed spot can correspond to the projection of a spot's position onto the image plane of the camera as defined by a corresponding perspective transformation. The PSD camera and/or SPD camera can produce the location information of each spot on the camera when the modulation and signal extraction techniques described herein are used together in a system. The camera position of each spot can be deduced from the signals generated from PSD and/or SPD camera in conjunction with digital signal processor. For the purpose of describing various embodiments herein, the term PSD camera or SPD camera is used to describe a position sensitive camera which can be a PSD camera, SPD camera or their equivalents. Using the measured camera positions of one or more spots and information related to the distance between the spots, the position (x, y) of the PSD camera in one plane and the rotation (θ) of the PSD camera around an axis normal to that plane can be determined. The position and orientation of the camera defined by (x, y, θ) is known as the pose of the camera. Similarly, using the measured camera positions of at least three spots and their nearest perpendicular distances to the camera plane, the 3-D position (x,y,z) of the PSD camera and its angles of rotation around each axis of a 3-D coordinate system (α, β, θ) can be determined.

Any particular spot's nearest perpendicular distance the the plane of the camera can be determined by measuring the camera position of the spot centroid from two separate camera locations on a plane that is parallel to the camera plane, where the distance of separation from the two camera positions is known. For example, a mobile sensor can be moved a pre-determined distance by an autonomously mobile object in any single direction parallel to the floor, where the floor is assumed to be planar. Triangulation can then be employed to calculate the nearest perpendicular distance of the spot to the camera plane. The resulting distance can then be stored and used for each calculation of pose involving that particular spot, in either 2-D or 3-D. Further, this measurement can be repeated multiple times and the resulting data can be statistically averaged to reduce errors associated with measurement noise.

Another embodiment of the method and apparatus described herein uses one two-dimensional PSD camera and one IR emitter. The IR emitter projects a spot on the ceiling, and the PSD camera faces the ceiling such that its field of view intersects at least a portion of the plane that defines the ceiling onto which the spots are projected. The PSD camera and associated signal extraction methods can provide indications for a measurement of the distance from the camera to the spot and the heading from the camera to the centroid of the spot relative to any fixed reference direction on the camera. The distance measurement defines a circle centered at the spot centroid, projected onto the plane of the camera. In one example, the illustrated embodiment can be used for an application in which it is desired to position a device relative to the spot. Advantageously, when the camera is underneath the spot on the ceiling, then the camera position is at the center of the PSD camera.

One or more signal processors are used in the embodiment to determine the pose of the object of interest 201. In one of the embodiments, the signal processors perform one or all of the functions below, other functions can also be incorporated into other signal processors described herein:
a. Time-Frequency transform algorithm
b. Computation of spot x, y
c. Computation of pose

Time-Frequency Transform (TFT) Algorithm

The Time-Frequency transform algorithm may be employed to measure amplitudes of multiple signals when each signal is modulated at separate and unique frequencies simultaneously. When the light from each spot is modulated at a separate and unique frequency, the resulting electrical signals from the PSD and/or SPD camera can thus be measured independently and simultaneously.

Spot (x, y) Calculation

After the TFT calculations, the x,y position of each spot can be calculated in camera coordinates, and calibrations and corrections can be applied to optimize the accuracy of the result.

In this way, the raw TFT magnitudes are transformed into accurate, corrected spot positions, X and Y.

Object Pose Calculation

Once the spot (x,y) is calculated for each spot, the object pose can be calculated. This calculation can be performed for each enclosure environment respectively.

In yet another embodiment, the localization sensor system further includes processors to perform the functions of calibrations and to deliver a host interface.

The host communication functions can be in serial or parallel communication at an optimized data rate to provide external and internal communication between the processors and external control units of the object.

A calibration function can be implemented to conduct both factory and real-time calibration including the size of the enclosure environment, optical alignment and rotation and non-linearity.

Embodiments of the method and apparatus advantageously enable an object to estimate its position and orientation relative to a global or local reference frame. Various embodiments have been described above. Although this invention has been described with reference to these specific embodiments, the descriptions are intended to be illustrative of the invention and are not intended to be limiting. Various modifications and applications may occur to those skilled in the art without departing from the true spirit and scope of the invention.

### Appendix A

### Incorporation by Reference of Commonly Owned Applications

The following patent applications, commonly owned and filed on the same day as the present application, are hereby incorporated herein in their entirety by reference thereto:

| | Application No. and | Attorney |
|---|---|---|
| Title | Filing Date | Docket No. |
| “Methods And Apparatus | Provisional Application | EVOL.0050PR |
| For Position Estimation | 60/557,252 | |
| Using Reflected Light | Filed Mar. 29, 2004 | |
| Sources” | | |
| “Circuit for Estimating | Provisional Application | EVOL.0050-1PR |
| Position and Orientation | 60/602,238 | |
| of a Mobile Object” | Filed Aug. 16, 2004 | |
| “Sensing device and | Provisional Application | EVOL.0050-2PR |
| method for measuring | 60/601,913 | |
| position and orientation | Filed Aug. 16, 2004 | |
| relative to multiple light | | |
| sources” | | |
| “System and Method of | Provisional Application | EVOL.0050-3PR |
| Integrating Optics into | 60/602,239 | |
| an IC Package” | Filed Aug. 16, 2004 | |
| “Methods And Apparatus | Utility Application | EVOL.0050A |
| For Position Estimation | Ser. No. TBD | |
| Using Reflected Light | Filed Mar. 25, 2005 | |
| Sources” | | |
| “Circuit for Estimating | Utility Application | EVOL.0050A1 |
| Position and Orientation | Ser. No. TBD | |
| of a Mobile Object” | Filed Mar. 25, 2005 | |
| “System and Method of | Utility Application | EVOL.0050A3 |
| Integrating Optics into | Ser. No. TBD | |
| an IC Package” | Filed Mar. 25, 2005 | |

1. A sensing system for estimating position and orientation of an object relative to a global reference frame based on a plurality of projected light sources, comprising:
a light sensitive position sensor wherein said light sensitive position sensor is capable of generating a signal; and
a processor wherein said processor is in communication with said position sensor through said signal.

2. The system of claim 1, wherein said light sensitive position sensor comprises a 2-dimensional position-sensitive detector (“PSD”).

3. The system of claim 1, wherein said light sensitive position sensor comprises a segmented photodiode with more than one light sensitive segment.

4. The system of claim 1, wherein said light sensitive position sensor further comprises:
a camera; and
a processor unit.

5. The system of claim 1, wherein said light sensitive position sensor is a light-focusing device wherein said light focusing device is capable of permitting a controlled amount of image blur, providing a field of view and providing a controlled amount of light.

6. The system of claim 1, wherein said processor generates said position and orientation by extracting frequency components from said signal.

7. The system of claim 6, wherein said processor extracts said frequency components by using time-frequency transform algorithm.

8. The system of claim 1, wherein said processor comprises:
an amplifier;
an digital converter;
a signal processor; and
an input-output communication channel.

9. A method of estimating position and orientation of an object relative to a global reference frame based on a plurality of projected light sources, comprising:
focusing a plurality of images from said projected light sources onto an optical sensor;
converting said images into electrical signals representing centroids of said projected light sources;
extracting a plurality of position information of said projected light sources from, at least in part, said electrical signal; and
calculating said position and orientation of said optical sensor from said position information in said global reference frame based on said light sources.

10. The method of claim 9, wherein converting said images comprises reading said electrical signal from an imager.

11. The method of claim 10, wherein converting said images comprises reading electrical signals from said imager and a lens.

12. The method of claim 11, wherein said image comprises reading said electrical signals from said imager, an optical filter and said lens.

13. The method of claim 9, wherein extracting said plurality of position information comprises decomposing said electrical signals into a plurality of frequency components.

14. The method of claim 9, wherein extracting said position information comprises decomposing said electrical signals into a plurality of frequency components and searching various frequencies for components that satisfy a pre-determined criteria.

15. A sensing system for providing position and orientation of an object to communicate with a control unit wherein said control unit provides instructions to move said object autonomously, comprising:
a light sensitive position sensor wherein said position sensor is capable of generating a signal;
a processor wherein said processor is in communication with said light sensitive position sensor through said signal;
a plurality of projected light sources;
a communication channel to said control unit; and
a memory to store output information from said processor.

16. The system of claim 15, wherein said light sensitive position sensor comprises a 2-dimensional position-sensitive detector (“PSD”).

17. The system of claim 15, wherein said light sensitive position sensor comprises a segmented photodiode with more than one light sensitive segment.

18. The system of claim 15, wherein said light sensitive position sensor further comprises:
a camera; and
a processor unit.

19. The system of claim 15, wherein said light sensitive position sensor is a light-focusing device wherein said light focusing device is capable of permitting a controlled amount of image blur, providing a field of view and providing a controlled amount of light.

20. The system of claim 15, wherein said processor provides said position and orientation of said object by extracting frequency components from said signal.

21. The system of claim 20, wherein said processor extracts said frequency components by using time-frequency transform algorithm.

22. A sensing system for providing position and orientation of an autonomous vehicle in an enclosure environment, comprising:
a light source;
a plurality of light spots wherein said light spots illuminating at frequencies distinct from one another;
a position sensitive detector wherein said PSD capture at least two images corresponding to said light spots;
a plurality of electrical signals produced by said PSD corresponding to physical positions on PSD of said images;
a signal processor wherein said signal processor converts said electric signals into digital representations of said positions of said images;
a digital processor wherein said digital processor produces said position and orientation from said digital representation; and
a communication channel wherein said communication channel provides said position and orientation to said vehicle.
